(19) United States
(12) Patent Application Publication
(10) Pub. No.: US 2006/0132025 A1
(43) Pub. Date: Jun. 22, 2006

(54) Flexible display designed for minimal mechanical strain

(75) Inventors: Zhanjun Gao, Rochester, NY (US); Richard W. Wien, Pittsford, NY (US); Tabrez Y. Ebrahim, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/020,910

(22) Filed: Dec. 22, 2004

(51) Int. Cl. H05B 33/26; H05B 33/00

(52) U.S. Cl. 313/503; 313/504; 313/506

(57) ABSTRACT

The invention relates to a balanced optical display comprising a flexible substrate, an electrical optical display element comprising at least one conductive layer adjacent to the display element wherein at least one of the conductive layers has an elongation to break of less than 2 percent, and a balancing layer on the side opposite to the substrate, wherein the thickness and Young's modulus of each layers of the display is selected in such a way so that the display capable of being formed to a radius of curvature of 10 cm without damage.

### FIELD OF THE INVENTION

This invention is in the field of electronic displays and, more particularly, it is in the field of a design to minimize mechanical strain in the manufacture or use of a flexible electronic display.

### BACKGROUND OF THE INVENTION

Most of commercial displays devices, for example, liquid crystal displays (LCD), or solid-state organic light-emitting diode (OLED) are rigid. LCD comprises two plane substrates, commonly fabricated by a rigid glass material, and a layer of a liquid crystal material or other imaging layer, and arranged in-between said substrates. The glass substrates are separated from each other by equally sized spacers being positioned between the substrates, thereby creating a more or less uniform gap between the substrates. Further, electrode means for creating an electric field over the liquid crystal material are provided and the substrate assembly is then placed between crossed polarizers to create a display. Thereby, optical changes in the liquid crystal display may be created by applying a voltage to the electrode means, whereby the optical properties of the liquid crystal material disposed between the electrodes is alterable.

There is substantial and growing interest in the development of flexible electronic displays for applications that range from intelligent labels for inventory control to large format displays. This technology has great potential for many such applications due to inherent low costs and high throughput of the manufacturing process. A flexible display is defined in this disclosure as a flat-panel display using thin, flexible substrate, which can be bent to a radius of curvature of a few centimeters or less without loss of functionality. Flexible displays are considered to be more attractive than conventional rigid displays. They allow more freedom in designed, promise smaller and more rugged devices. On the other hand, under bending moments, the rigid display tends to lose its image over a large area, due to the fact that the gap between the substrates changes, thereby causing the liquid crystal material to flow away from the bending area, resulting in a changed crystal layer thickness. Consequently, displays utilizing glass substrates are less suitable, when a more flexible or even bendable display is desired.

Another advantage of using flexible substrates is that a plurality of display devices can be manufactured simultaneously by means of continuous web processing such as, for example, reel-to-reel processing. The manufacture of one or more display devices by laminating (large) substrates is alternatively possible. Dependent on the width of the reels used and the length and width of a reel of (substrate) material, a great many separate (display) cells or (in the case of “plastic electronics”) separate (semi-) products can be made in these processes. Such processes are therefore very attractive for bulk manufacture of said display devices and (semi-) products.

Some efforts have been made in the field of exchanging the above described glass substrates with substrates of a less fragile material, such as plastic. Plastic substrates provide for lighter and less fragile displays. One display using plastic substrates are described in the patent document U.S. Pat. No. 5,399,390. However, the natural flexibility of the plastic substrates presents problems, when trying to manufacture liquid crystal displays in a traditional manner. For example, the spacing between the substrates must be carefully monitored in order to provide a display with good picture reproduction. An aim in the production of prior art displays utilizing plastic substrate has therefore been to make the construction as rigid as possible, more or less imitating glass substrates. Thereby the flexible properties of the substrates have not been utilized to the full extent.

U.S. Pat. No. 6,710,841 discloses a liquid crystal display device having a first and a second substrate, being manufactured in a flexible material with a liquid crystal material is disposed between the substrates. Together, the substrates form an array of cell enclosures, each containing an amount of liquid crystal. Further, each of said cell enclosures is separated from the adjacent enclosures by intermediate flexible parts. By creating a display from a flexible material and subdividing the display into a plurality of separate cell enclosures, the flexible, bendable display will bend along an intermediate part rather than through a liquid crystal filled cell, thereby maintaining the display quality, since the cells or “pixels” of the display are left intact. U.S. Pat. No. 6,710,841 only applies to displays for which the display module is stiff and therefore, has a high bending stiffness in comparison with the substrate. However, as disclosed in EP 1403687 A2, some displays have nano-dimension conductive layer and display layer. For such display, the intermediate part has a similar bending stiffness in comparison with the liquid crystal enclosures. Therefore, the enclosures experience bending similar to the intermediate part. The flexibility of the display is limited by the bending limitation of the display enclosures. EP 1403687 A2 also calls for two substrates that sandwich the display enclosures in the middle.

WO 02/067329 discloses a flexible display device comprising a flexible substrate, a number of display pixels arranged in a form of rows and columns on the surface of the substrate, a number of grooves in the surface of the substrate, each of which is formed in between adjacent two rows or columns of the display pixels, and connection lines for electrically interconnecting the plurality of display pixels, thereby providing flexibility to the display device and, at the same time, minimizing the propagation of mechanical stress caused when the display device is bent or rolled. A method of manufacturing the display device is also disclosed.

US Patent Application 2003/0214612 describes the use of sliding laminar layers in addition to the display element in order to reduce the strain on the display element but this approach involves requires a more complicated manufacturing procedure and does not lead to the ability to bend the display to small radii of curvature.

US Patent Application 2003/0157783 describes the use of sacrificial layers in the manufacture of high performance systems. In one embodiment it is disclosed that “applying a layer to the capping material side of the released system to form a configuration wherein the system is substantially within a bending-strain reduced neutral plane.” This method has a distinct disadvantage in that it requires a complicated manufacturing process and no information is disclosed with respect to composition and/or thickness of the capping layer.

WO Patent Application 2004086530 describes a flexible electroluminescent device having a first and second substrate enclosing an electroluminescent element and a brittle layer which fails when stressed by flexure is made more robust by positioning the mechanical neutral line associated with a flexure in or near such brittle layer. Positioning the mechanical neutral line in or near the brittle layer is achieved by adapting, relative to one another, the stiffness of the first and second substrate. According to US Patent Application 2004086530 the process of adapting, relative to one another, the stiffness of the first and second substrate so as to arrange a mechanical neutral line on or near a brittle layer may proceed through a experimental approach or computer simulation. In the experimental approach a series of display devices is manufactured and flexed to a predetermined radius of curvature a predetermined number of times to determine the point at which the brittle layer fails. Inspection of the failed flexible display device may show on which side of the brittle layer the mechanical line is located. Having established on which side of the brittle layer the mechanical neutral line is located the stiffness of the first and/or second substrate is adapted to move the neutral line towards the brittle layer. This process is repeated until the mechanical neutral line passes through or near the brittle layer. In the second approach, computer simulations are used in method to establish whether, a mechanical neutral line of a flexed flexible display device is passes through or near a brittle layer of such device. In both cases, the implementation of such an approach is rather complex, requiring either the iterative testing, or the skills and knowledge of Finite Element Method and Analysis, as well as familiarity of commercial simulation software. Therefore, there still a need to develop a simple method for providing a more flexible display.

The use of these displays and the manufacturing process may result in mechanical strain when the display is bent. For example, manufacture of a flexible display using a roll coating machine may require transport of the display over and around rollers with diameters as small as a few centimeters. In the actual use of a flexible display, it may be desirable to store the display in a tightly rolled condition where the stored roll may have a diameter of a few centimeters or less. In particular, it is the conductive layers in the display that will experience strain during the bending process, and that will result in their breaking and making the device unusable. For example, conductive layers are most often fabricated from a material such as indium tin oxide (ITO). ITO layers typically found in electronic displays are particularly sensitive to strain and will often fracture if subjected to an elongation of less than 1% of their total length. The prior art has attempted to address this problem but a broadly applicable solution is still needed.

### PROBLEM TO BE SOLVED BY THE INVENTION

The invention addresses the continuing need for a method to design and manufacture flexible displays with minimal mechanical strain.

### ADVANTAGEOUS EFFECT OF THE INVENTION

The invention provides a method to minimize and/or eliminate mechanical strain in flexible electronic structures. The method is applicable to multi-layer electronic structures constructed from a variety of flexible materials.

### SUMMARY OF THE INVENTION

In answer to the aforementioned and other problems of the prior art the invention provides a display device comprising a flexible substrate, an electrical optical display element comprising at least one conductive layer adjacent to the display wherein at least one of the conductive layers has an elongation to break of less than 2 percent and a balancing layer wherein the balanced display is capable of being formed to a radius of curvature of 10 cm or less without damage.

### BRIEF DESCRIPTION OF THE DRAWINGS

In the detailed description of the preferred embodiments of the invention presented below, reference is made to the accompanying drawings in which:

FIG. 1 is a schematic diagram showing the structure of a prior art flexible electronic display;

FIG. 2 is a schematic diagram showing the structure of a flexible electronic display made according to the present invention;

FIG. 3 is a schematic diagram of an OLED flexible electronic display;

FIG. 4 is a schematic diagram of an OLED flexible electronic display made according to the present invention;

FIG. 5 is a graph showing the results of mechanical strain calculations pertaining to the electronic displays of FIGS. 1 and 2;

FIG. 6 is a graph showing the minimum bending radius for breakage as a function of support thickness for the display of FIG. 1.

FIG. 7 is a graph showing the results of mechanical strain calculations pertaining to the electronic displays of FIGS. 3 and 4; and

FIG. 8 is a graph showing the minimum bending radius for breakage as a function of support thickness for the display of FIG. 3.

### DETAILED DESCRIPTION OF THE INVENTION

The invention has numerous advantages over prior art flexible optical display devices. It allows more freedom in designing smaller and more rugged devices. It also makes it possible to produce curled displays. Another advantage of using flexible substrates is that a plurality of display devices can be manufactured simultaneously by means of continuous web processing such as, for example, reel-to-reel processing. The manufacture of one or more display devices by laminating (large) substrates is alternatively possible. Dependent on the width of the reels used and the length and width of a reel of (substrate) material, a great many separate (display) cells or (in the case of “plastic electronics”) separate (semi-) products can be made in these processes. Such processes are therefore very attractive for bulk manufacture of said display devices.

These and other advantages will become apparent from the detailed description below.

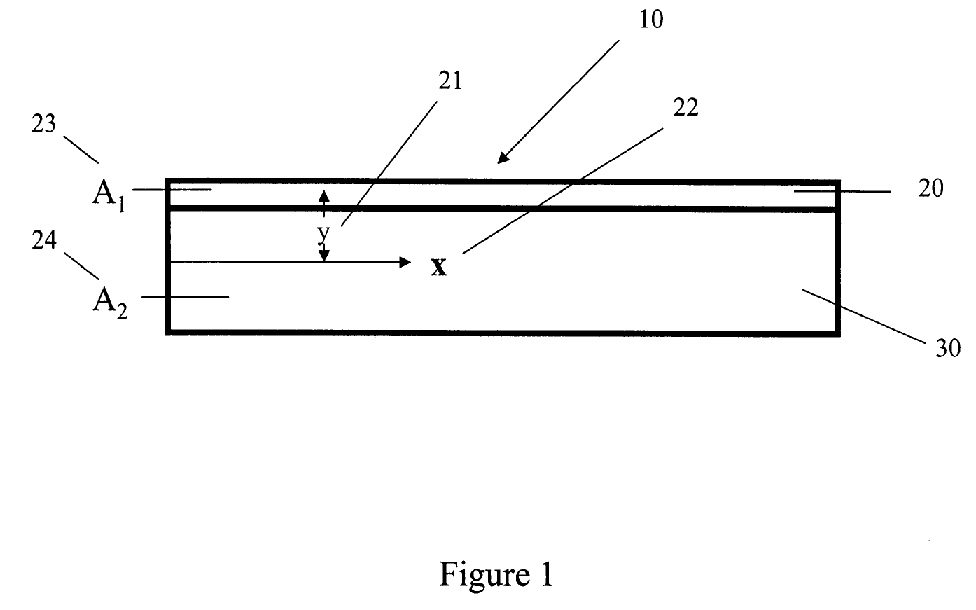

First, the means of calculating the strain in a flexible display assembly will be described. Turning first to FIG. 1, there is shown a prior art flexible display assembly 10 comprising a flexible support layer 30 and an electrical optical display module or element 20. The flexible substrate layer 30 could be polyester, polyolefin and polycarbonate materials and their derivatives. In addition the flexible substrate 30 could be made from thin(less than 1000 micrometers) metals such as aluminum, aluminum alloy, anodized aluminum, stainless steel, titanium, molybdenum or copper. The electrical optical display element 20 typically comprises several thin layers associated with imaging, typically comprising one or more light-emitting or light modulating layers and a conductive anode layer and cathode layer disposed adjacent to at least one side of the various light emitting or light modulating layers. Conductive layers are fabricated from a material such as indium tin oxide (ITO) as an anode layer. ITO layers typically found in electronic displays are particularly sensitive to strain and will often fracture if subjected to an elongation of less than 1% of their total length.

For flexible display with organic light emitting diode (OLED), other common transparent anode materials used in this invention are indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where light emission is viewed only through the cathode electrode, the transmissive characteristics of anode are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize shorts or enhance reflectivity.

For flexible display with organic light emitting diode (OLED), when light emission is viewed solely through the anode, the cathode layer used in this invention can be comprised of nearly any conductive material. Desirable materials have good film-forming properties to ensure good contact with the imaging layer, promote electron injection at low voltage, and have good stability. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) in contact with the imaging layer which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. Other useful cathode material sets include, but are not limited to, those disclosed in U.S. Pat. Nos. 5,059, 861, 5,059,862, and 6,140,763.

When light emission is viewed through the cathode, the cathode must be transparent or nearly transparent. For such applications, metals must be thin or one must use transparent conductive oxides, or a combination of these materials. Optically transparent cathodes have been described in more detail in U.S. Pat. No. 4,885,211, U.S. Pat. No. 5,247, 190, JP 3,234, 963, U.S. Pat. No. 5,703,436, U.S. Pat. No. 5,608,287, U.S. Pat. No. 5, 837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, U.S. Pat. No. 6,278, 236, and U.S. Pat. No. 6,284,393.

The flexible strain-balancing layer 50 should be transmissive, and can be any flexible self-supporting plastic film that supports the thin conductive metallic film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible strain-balancing layer 50 must have sufficient thickness and mechanical integrity so as to be self-supporting, yet should not be so thick as to be rigid. Typically, the flexible plastic substrate is the thickest layer of the composite film in thickness. Consequently, the substrate determines to a large extent the mechanical and thermal stability of the fully structured composite film.

Another significant characteristic of the flexible strain-balancing layer is its glass transition temperature (Tg). Tg is defined as the glass transition temperature at which plastic material will change from the glassy state to the rubbery state. It may comprise a range before the material may actually flow. Suitable materials for the flexible plastic substrate include thermoplastics of a relatively low glass transition temperature, for example up to 150° C., as well as materials of a higher glass transition temperature, for example, above 150° C. The choice of material for the flexible plastic substrate would depend on factors such as manufacturing process conditions, such as deposition temperature, and annealing temperature, as well as post-manufacturing conditions such as in a process line of a displays manufacturer. Certain of the plastic substrates discussed below can withstand higher processing temperatures of up to at least about 2000 C, some up to 3000-350° C., without damage.

Typically, the flexible strain-balancing layer can be made of polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester. Various cyclic polyolefins are suitable for the flexible plastic substrate. Examples include Artong made by Japan Synthetic Rubber Co., Tokyo, Japan; Zeanor T made by Zeon Chemicals L.P., Tokyo Japan; and Topas® made by Celanese A. G., Kronberg Germany. Arton is a poly(bis(cyclopentadiene)) condensate that is a film of a polymer. Alternatively, the flexible plastic substrate can be a polyester. A preferred polyester is an aromatic polyester such as Arylite. Although various examples of plastic substrates are set forth above, it should be appreciated that the substrate can also be formed from other materials such as glass and quartz.

The flexible plastic substrate can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec.” Lintec contains UV-cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

By reference to equation (1) below, it can be seen that the strain experienced by the electrical optical display element 20 when the display assembly 10 is bent is related to the radius p of the curvature (not shown) of the flexible display assembly 10 and the distance y 21 of the electrical optical display element 20 from the neutral axis X 22, i.e.,

$${σ}_{1} = \frac{y}{ρ} {E}_{1} \qquad ( 1 )$$

where σ₁ and E₁ are the normal strain and Young's modulus, respectively, of the electrical optical display element 20. The neutral axis X 22, as defined by the distance y 21 from electrical optical display element 20, is located at the position where the resultant normal strain is zero as determined by equations (2) or (3) below,

$$\begin{matrix}{\int }_{A}^{} σ ⅆ A = {\int }_{{A}_{1}} {σ}_{1} ⅆ A + {\int }_{{A}_{2}} {σ}_{2} ⅆ A = \frac{1}{ρ} \{ {E}_{1} {\int }_{{A}_{1}} y ⅆ A + {E}_{2} {\int }_{{A}_{2}} y ⅆ A \} = 0 \\ or & ( 2 ) \\ {E}_{1} {\int }_{{A}_{1}} y ⅆ A + {E}_{2} {\int }_{{A}_{2}} y ⅆ A = 0 & ( 3 )\end{matrix}$$

where A₁ 23 and A₂ 24 are the cross-sectional areas of the electrical optical display element 20 and the display support 30, respectively, and A=A₁+A₂ . E₁ and E₂ are the Young's modulus of the electrical optical display element 20 and the display support 30, respectively.

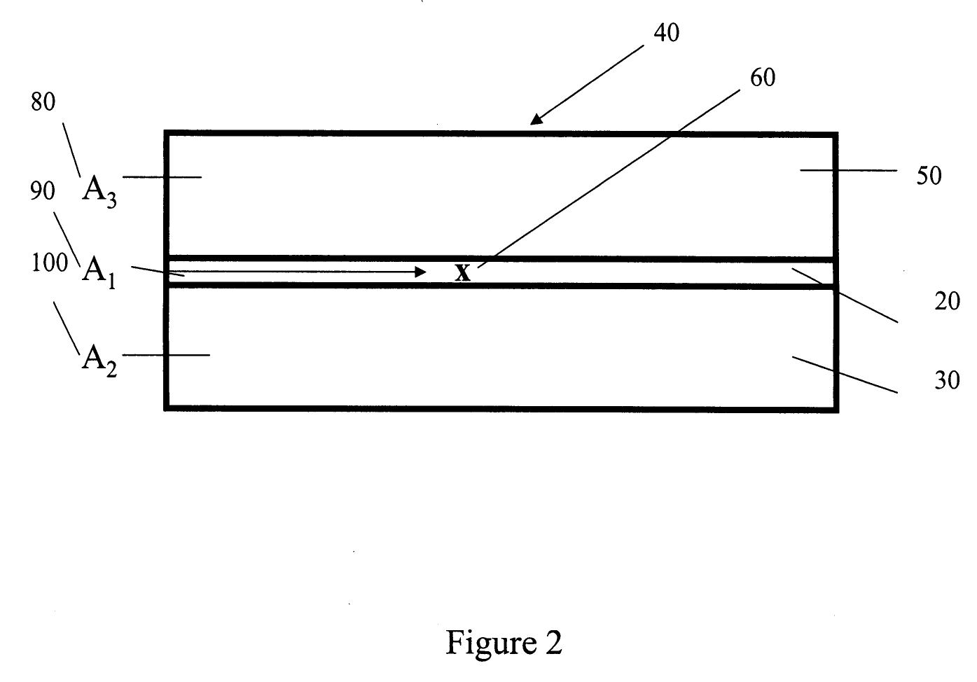

Referring now to FIG. 2, there is shown a flexible display assembly 40 made in accord with the present invention, comprising a flexible support layer 30 and a electrical optical display element 20 identical to those described previously for the display assembly of FIG. 1. The display assembly 40 also comprises a flexible strain-balancing layer 50 placed over the top of electrical optical display element 20.

For the display assembly 40 shown in FIG. 2, the position of the neutral axis X 60 can be determined using equation (4),

$${E}_{1} {\int }_{{A}_{1}} y ⅆ A + {E}_{2} {\int }_{{A}_{2}} y ⅆ A + {E}_{3} {\int }_{{A}_{3}} y ⅆ A = 0 \qquad ( 4 )$$

where A₁ 80, A₂ 90 and A₃ 100 are the cross-sectional areas of electrical optical display element 20, display support 30 and balancing layer 50, respectively, and E₁, E₂ and E₃ are the corresponding Young's moduli for these layers. In equation 4, y is the distance of the neutral axis X 60 from the electrical optical display element 20. It is easy to see from Equation (4) there are two ways to select the balancing layer so that the neutral axis X 60 is located at the centerline of the electrical optical display element 20 (y=0). One way is to select the material for the balancing layer 50 to have the same Young's modulus and thickness with the display support 30. Another way is to select a material with different Young's modulus as the balancing layer. In this case, the thickness of the balancing layer 50 needs to be different from that of the display support 30. The required thickness of the balancing layer 50 can be determined using Equation (4). If the balancing layer 50 has a higher Young's modulus than that of the display support 30, the required thickness for the balancing layer 50 will need to be less than that of the display support 30. On the other hand, if the balancing layer 50 has a lower Young's modulus than that of the display support 30, the required thickness for the balancing layer 50 will need to be greater than that of the display support 30. In general, in designing the balancing layer 50, one can select thickness for given Young's modulus or select Young's modulus for given thickness so that Equation (4) is satisfied and the position of neutral axis X 60 is at the centerline of the electrical optical display element 20, as illustrated in FIG. 2.

The preceding discussion has served to illustrate that for a flexible display assembly containing electrical optical display element, display support and other layers, a new strain-balancing layer may be added with appropriate selection of thickness and Young's modulus in such as way so that the neutral axis of the new flexible display assembly is positioned at the centerline of the electrical optical display element.

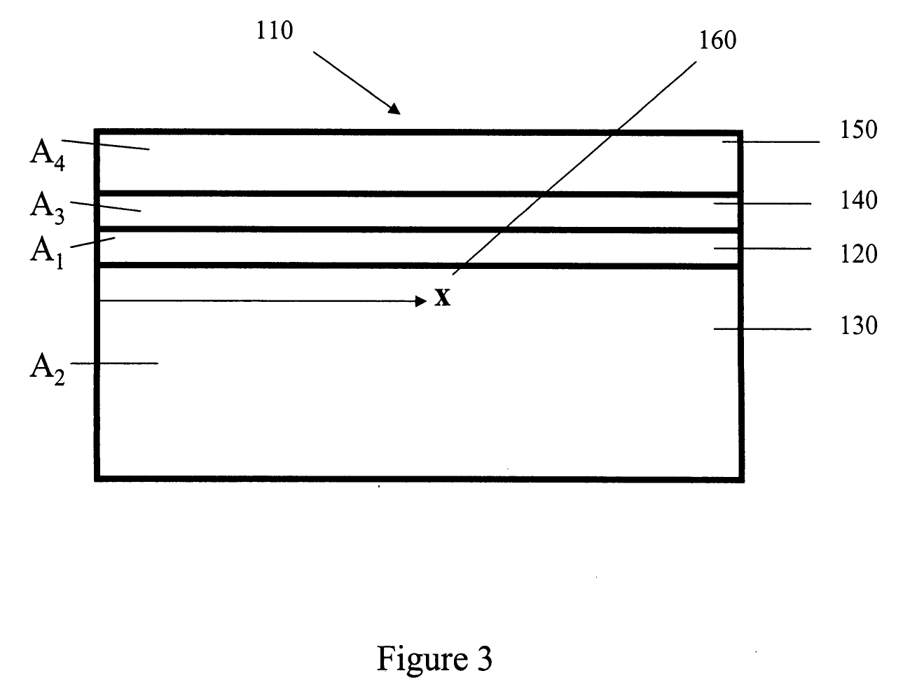

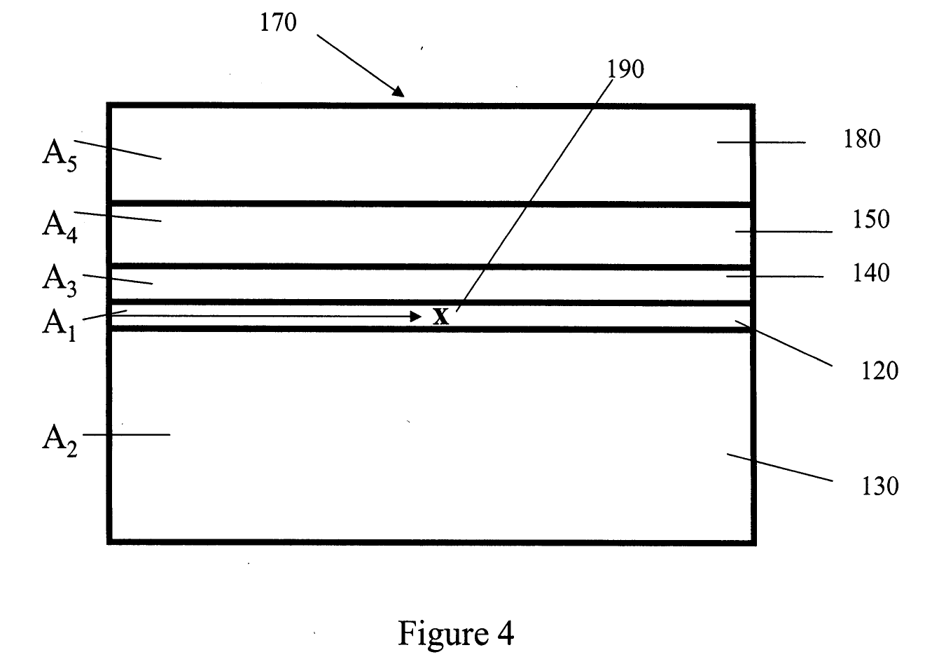

By way of yet a further illustration, a flexible organic light emitting diode (OLED)display assembly 110 is shown in FIG. 3. The display assembly 110 comprises a flexible aluminum display support 130, a electrical optical display element 120, a thin flexible glass layer 140 (which serves as a barrier to moisture and oxygen), and a flexible top layer 150 of polyethylene terphthalate (PET) for mechanical protection. Using the calculation methodology previously described for the display assemblies of FIGS. 1 and 2, it can be determined that the position of the neutral axis X 160 is located in the support layer 130 as shown in FIG. 3. In FIG. 4 is shown a display assembly 170 with layers identical to those of the display assembly 110 of FIG. 3 except that an additional balancing layer 180 has been added over the top of the assembly 170. Once again, in a manner analogous to the methods applied to the display assemblies of FIGS. 1-3, the thickness and Young's modulus of the balancing layer 180 have been selected in such a way that when they are utilized in equation (5) below, the position of the neutral axis X 190 is calculated to be at the centerline of the electrical optical display element 120.

$${E}_{1} {\int }_{{A}_{1}} y ⅆ A + {E}_{2} {\int }_{{A}_{2}} y ⅆ A + {E}_{3} {\int }_{{A}_{3}} y ⅆ A + {E}_{4} {\int }_{{A}_{4}} y ⅆ A + {E}_{5} {\int }_{{A}_{5}} y ⅆ A = 0 \qquad ( 5 )$$

The following discussion and examples illustrate the practice of the invention, but the examples are not intended to be exhaustive of all possible variations of the invention.

In order to illustrate the operation of the current invention even more clearly, the following examples provide additional detail regarding the actual dimensions and specifications of the layers in the display assemblies disclosed in FIGS. 1-4. The results of strain calculations and the determination of the positions of the neutral axes are also shown in these examples.

From the previous discussion, it is clear from equations (1)-(3) that for a given bending radius of curvature, the strain in the electrical optical display element 20 is related to the thickness of the display support 30. When the display support is relatively thicker, the neutral axis of the flexible assembly 10 is farther away from the electrical optical display element 20, and therefore, the distance y 21 from the neutral axis to the electrical optical display element 20 is larger, which in turn yields a higher strain in the electrical optical display element 20 (Equation (1)). On the other hand, in the practice of the present invention when a strain-balancing layer with appropriately selected properties is added to the assembly (as illustrated in FIGS. 2 and 4), the neutral axis may be moved to the centerline of the electrical optical display element. Under these conditions, the strain in the electrical optical display element is independent of the thickness of the display support.

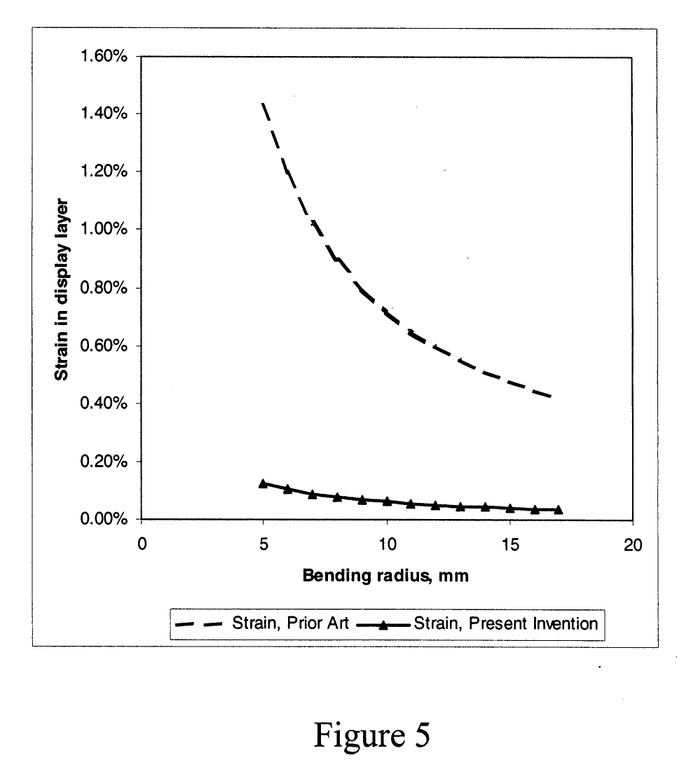

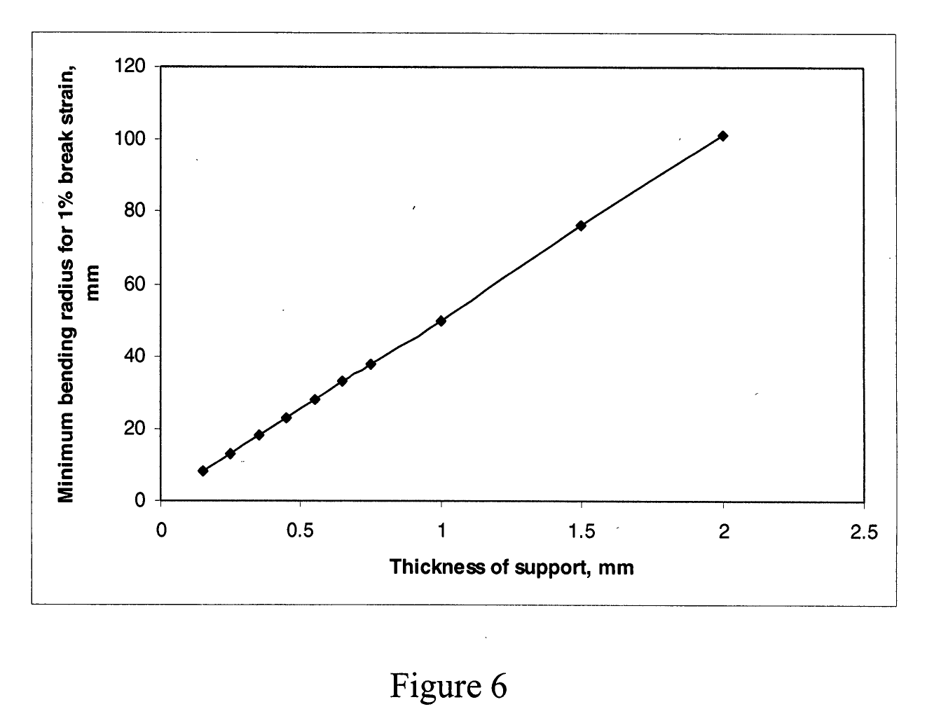

FIG. 5 shows the strains as a function of bending radius calculated using equation (1) for the prior art display assembly shown in FIG. 1 and for the inventive display assembly of FIG. 2, respectively. In the examples calculated, the display support 30 has a thickness of 0.125 mm, while the electrical optical display element has a thickness of 0.0125 mm. It is clear from the curve in FIG. 5 for the inventive assembly of FIG. 2 that there is only a very small strain in the electrical optical display element 20. Even when the bending radius of curvature is below 5 mm, the strain in the electrical optical display element 20 is still below 0.2%, well below the break strain (the critical strain for break of the layer) of the materials in the electrical optical display element such as ITO. The break strain for ITO layers typically used in this type of electronic display is about 0.5% to 1.0%; i.e., these layers will fracture when subjected to a strain force that elongates them more than about 0.5% -1.0% of their total length. Furthermore, as the thickness of the display support 30 increases, the strain in the electrical optical display element 20 of the prior art display increases accordingly. This is illustrated by the results of calculations shown in FIG. 6 for the display assembly of FIG. 1 with a electrical optical display element 20 with a break strain of 1%. FIG. 6 shows that the minimum bending radius (the minimum bending radius it can be bent to without break) of the flexible display assembly 10 increases linearly as a function of the thickness of the display support 30. When the display support 30 is 2 mm thick, the minimum bending radius of the flexible display assembly 10 is 100 mm. On the other hand, the strain in the electrical optical display element 20 when a strain-balancing layer is added is independent of the thickness of the display support 30, and remains well below 0.2%. As shown in FIG. 5, the inventive display of FIG. 2 can be bent into a radius of curvature well below 5 mm while the strain remains below 0.2%.

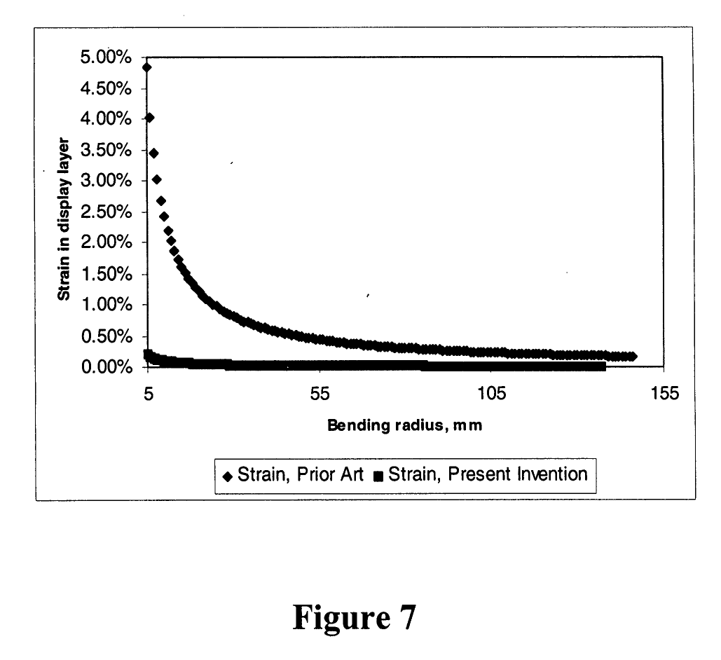

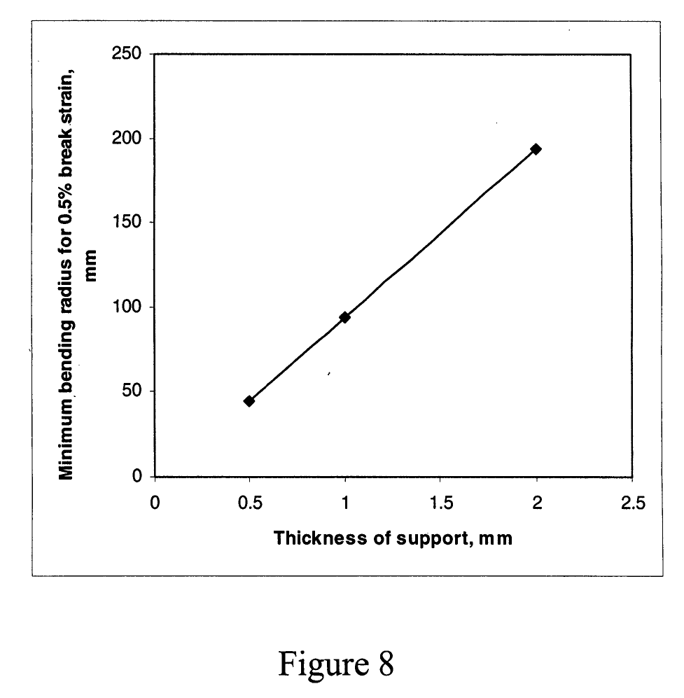

FIG. 7 shows the results of strain calculations for the prior art flexible OLED display assembly of FIG. 3 and the inventive flexible OLED display of FIG. 4 that incorporates a strain-balancing layer. In the examples of FIGS. 3 and 4 the aluminum substrate layer 130 has a thickness of 500 microns and a Young's modulus of 70 Gpa. The electrical optical display element 120 has a thickness of 20 microns. The glass layer 140 has a thickness of 60 microns and a Young's modulus of 50 GPa. The PET layer 150 has a thickness of 150 microns and a Young's modulus of 4 GPa. The balancing layer 180 has a thickness of 1.84 millimeters with a Young's modulus 4 GPa. It is clear from the results of calculations presented in FIG. 7 that the present invention with the balancing layer 180, shown in FIG. 4, has a very small strain in the electrical optical display element 120. Even when the bending radius of curvature is as low as 10 mm, the strain in the electrical optical display element 20 is still below 0.5%, well below the break strain (the critical strain for break of the layer) of the materials in the electrical optical display element such as ITO. Furthermore, for the prior art display shown in FIG. 3, as the thickness of the display support 130 increases, the strain in the electrical optical display element 120 increases accordingly. As shown in FIG. 8, for a electrical optical display element 120 with a break strain 0.5%, the minimum bending radius (the minimum bending radius it can be bent to without breaking) of the flexible display assembly 120 increases linearly as a function of the thickness of the display support 130. When the display support 30 is 2 mm thick, the critical radius of curvature of the flexible display assembly 110 is 200 mm. On the other hand, as shown in FIG. 7, the strain in the inventive electrical optical display element 120 of FIG. 4 is independent of the support thickness, and remains below 0.5%. The inventive display of FIG. 4 can be bent into a radius of curvature below 10 mm, as compared to the prior art display with minimum bending radius of only 50 mm.

The invention has been described in detail with particular reference to certain preferred embodiments thereof, but it will be understood that variations and modifications can be effected within the spirit and scope of the invention.

1. A balanced optical display comprising a flexible substrate, an electrical optical display element comprising at least one conductive layer adjacent to the display element wherein at least one of the conductive layers has an elongation to break of less than 2 percent, and a balancing layer on the side opposite to the substrate, wherein the thickness and Young's modulus of each layers of the display is selected in such a way so that the display capable of being formed to a radius of curvature of 10 cm without damage.

2. The balanced optical display of claim 1 wherein the thickness and Young's modulus of each layers of the display is selected in such a way so that the elongation of the said at least one conductive layer is minimized.

3. The balanced optical display of claim 1 wherein the thickness and Young's modulus of each layers of the display is selected in such a way so that the elongation of the said at least one conductive layer is substantially zero.

4. The balanced optical display of claim 1 wherein said balanced display is capable of being formed to a radius of curvature of 5mm without damage.

5. The balanced optical display of claim 1 wherein said flexible substrate has a Young's modulus between 1 GPa to 8 Gpa.

6. The balanced optical display of claim 1 wherein the electrical optical display element comprises a liquid crystal display.

7. The balanced optical display of claim 1 wherein the electrical optical display element comprises an organic light emitting diode display.

8. The balanced optical display of claim 1 wherein said substrate has a thickness of between 1 mm and 20 mm.

9. The balanced optical display of claim 1 wherein said balancing layer has a thickness of between 1 mm and 20 mm.

10. The balanced optical display of claim 1 wherein said display element has a thickness of between 2 and 20 micrometers.

11. The balanced optical display of claim 1 wherein the conductive layers comprise indium tin oxide, indium-zinc oxide (IZO) and tin oxide.

12. The balanced optical display of claim 1 wherein the balancing layer is selected from at least one of a polymer layer, a glass layer, or a metal layer.

13. A balanced optical display comprising a flexible substrate, an electrical optical display element comprising at least one conductive layer adjacent to the display element wherein at least one of the conductive layers has an elongation to break of less than 2 percent, and a balancing layer as the flexible substrate on the side opposite to the substrate, wherein the thickness and Young's modulus of each layers of the display is selected in such a way so that Equation (4) is satisfied, wherein the Equation is
$${E}_{1} {\int }_{{A}_{1}} y ⅆ A + {E}_{2} {\int }_{{A}_{2}} y ⅆ A + {E}_{3} {\int }_{{A}_{3}} y ⅆ A = 0. \qquad ( 4 )$$

14. The balanced optical display of claim 13 wherein said balanced display is capable of being formed to a radius of curvature of 5 mm without damage.

15. The balanced optical display of claim 13 wherein said flexible substrate has a Young's modulus between 1 GPa to 8 GPa.

16. The balanced optical display of claim 13 wherein the electrical optical display element comprises a liquid crystal display.

17. The balanced optical display of claim 13 wherein the electrical optical display element comprises an organic light emitting diode display.

18. The balanced optical display of claim 13 wherein said substrate has a thickness of between 1 mm and 20 mm.

19. The balanced optical display of claim 13 wherein said balancing layer has a thickness of between 1 mm and 20 mm.

20. The balanced optical display of claim 13 wherein said display element has a thickness of between 2 and 20 micrometers.

21. The balanced optical display of claim 13 wherein the conductive layers comprise indium tin oxide, indium-zinc oxide (IZO) and tin oxide.

22. The balanced optical display of claim 13 wherein the balancing layer is selected from at least one of a polymer layer, a glass layer, or a metal layer.
